(19) United States
(12) Patent Application Publication
(10) Pub. No.: US 2014/0354482 A1
(43) Pub. Date: Dec. 4, 2014

(54) CERAMIC ANTENNA

(71) Applicant: Cirocomm Technology Corp., Tainan City (TW)

(72) Inventors: Tsai-Yi YANG, Tainan City (TW); Chia-Tsung WU, Tainan City (TW)

(73) Assignee: Cirocomm Technology Corp., Tainan City (TW)

(21) Appl. No.: 13/904,349

(22) Filed: May 29, 2013

(51) Int. Cl. H01Q 1/38

(52) U.S. Cl. CPC H01Q 1/38
USPC 343/700 MS

(57) ABSTRACT

A ceramic antenna includes a carrier and a radiation metal part. The carrier includes a plurality of long sides and a plurality of short sides. The radiation metal part is arranged on the carrier. The short sides are in arc-shape. Therefore, the long sides and the short sides are not easily broken when moving the ceramic antenna or covering the radiation metal part on the carrier. The defective rate of the ceramic antenna is decreasing.

### BACKGROUND OF THE INVENTION

1. Field of the Invention

The present invention relates to an antenna, and especially relates to a chip ceramic antenna.

2. Description of the Related Art

The wireless communication technology is progressing every day. Many portable electronic apparatuses, such as notebooks, mobile phones, and personal digital assistants, are slim and light. Therefore, the antennas for the portable electronic apparatuses are small, too. Or, the structures of the antennas have to be modified, so that the antennas can be arranged into the portable electronic apparatuses.

The chip ceramic antenna is the common multi-frequency antenna. The ceramic antenna is made of ceramic and is made as a cubic carrier. The carrier is covered by at least a radiation metal part for communication. The radiation metal part is electrically connected to a microstrip line of a base plate. The microstrip line is electrically connected to a coaxial cable. Signals are sent from the radiation metal part to a mainboard (for processing the signals) of an electronic apparatus through the microstrip line and the coaxial cable after the radiation metal part receives the signals.

The conventional ceramic antenna still has some disadvantages although the conventional ceramic antenna is minimized. Especially, the ceramic antenna is made in cubic shape with a plurality of long sides and a plurality of short sides. The long sides and the short sides are easily broken when moving the carrier or covering the radiation metal part on the carrier. Therefore, the defective rate of the ceramic antenna is high.

### SUMMARY OF THE INVENTION

In order to solve the above-mentioned problems, an object of the present invention is to provide a ceramic antenna having a carrier. The carrier has a plurality of arc-shaped (or chamfered) long sides and a plurality of arc-shaped (or chamfered) short sides. The arc-shaped long sides and the arc-shaped short sides are not easily broken when moving the ceramic antenna or covering the radiation metal part on the carrier. Therefore, the defective rate of the ceramic antenna is decreasing.

In order to achieve the object of the present invention mentioned above, the ceramic antenna includes a carrier and a radiation metal part. The carrier includes a plurality of long sides and a plurality of short sides. The radiation metal part is arranged on the carrier. The short sides are in arc-shape.

Moreover, a radius of the short side in arc-shape is between 0.1 mm and 1 mm. The radius of the short side in arc-shape is best between 0.4 mm and 0.6 mm (0.5±0.1 mm). The carrier further includes a plurality of grooves. The groove includes two straight long sides and two arc short sides (or two straight short sides). The long side is in arc-shape. A radius of the long side in arc-shape is between 0.1 mm and 1 mm. The radius of the long side in arc-shape is best between 0.4 mm and 0.6 mm (0.5±0.1 mm).

Moreover, the radiation metal part includes a first radiation metal part, a second radiation metal part, and a third radiation metal part. The first radiation metal part, the second radiation metal part, and the third radiation metal part are in different metal rectangular patterns or metal line patterns arranged on at least a surface of the carrier. The first radiation metal part is electrically connected to the second radiation metal part. The first radiation metal part and the second radiation metal part are not electrically connected to the third radiation metal part.

### BRIEF DESCRIPTION OF DRAWING

FIG. 1 shows a schematic diagram of the ceramic antenna of the present invention.

FIG. 2 shows another schematic diagram of the ceramic antenna of the present invention.

FIG. 3 shows an exploded view of the ceramic antenna and the base plate of the present invention.

FIG. 4 shows another exploded view of the ceramic antenna and the base plate of the present invention.

FIG. 5 shows an assembly drawing of the ceramic antenna and the base plate of the present invention.

FIG. 6 shows a schematic diagram of another embodiment of the ceramic antenna of the present invention.

FIG. 7 shows a schematic diagram of still another embodiment of the ceramic antenna of the present invention.

### DETAILED DESCRIPTION OF THE INVENTION

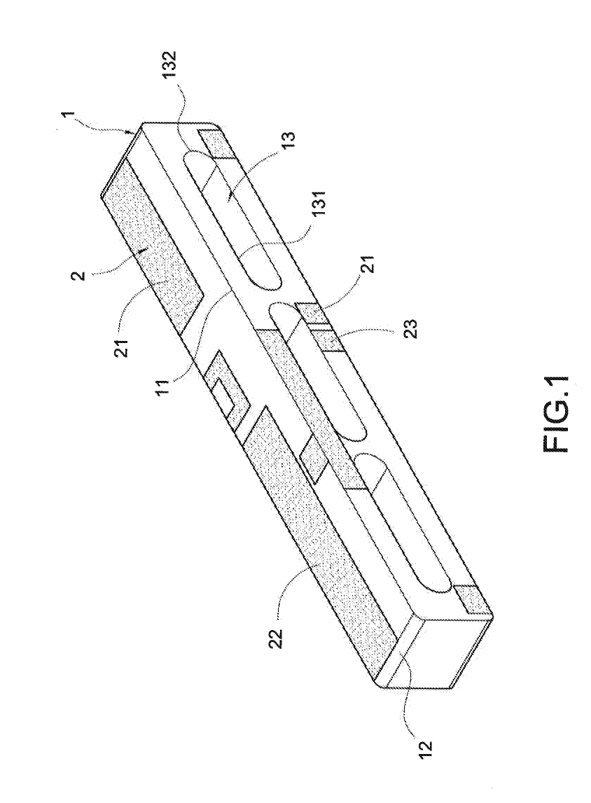

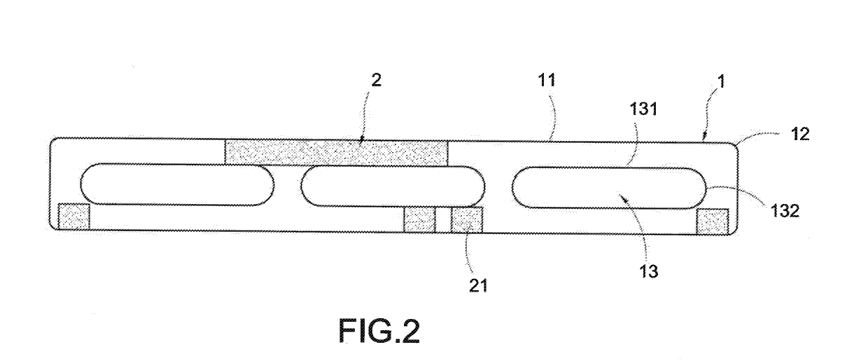

FIG. 1 shows a schematic diagram of the ceramic antenna of the present invention. FIG. 2 shows another schematic diagram of the ceramic antenna of the present invention. The ceramic antenna includes a carrier 1 and a radiation metal part 2.

The carrier 1 is of cubic shape and made of ceramic with high dielectric constant. The carrier 1 includes a plurality of long sides 11 and a plurality of short sides 12. The short side 12 is in arc-shape. A radius of the short side 12 in arc-shape is between 0.1 mm and 1 mm (best between 0.4 mm and 0.6 mm). Moreover, the carrier 1 further includes a plurality of grooves 13. The groove 13 includes two straight long sides 131 and two arc short sides 132.

The radiation metal part 2 includes at least a first radiation metal part 21, a second radiation metal part 22, and a third radiation metal part 23. The first radiation metal part 21, the second radiation metal part 22, and the third radiation metal part 23 are in different metal rectangular patterns or metal line patterns arranged on at least a surface of the carrier 1. Therefore, the carrier 1 is minimized. The first radiation metal part 21 is electrically connected to the second radiation metal part 22. The first radiation metal part 21 and the second radiation metal part 22 are not electrically connected to the third radiation metal part 23.

Because the short sides 12 are in arc-shape, the short sides 12 are not easily broken when manufacturing or moving the carrier 1. Therefore, the defective rate of the carrier 1 is decreasing.

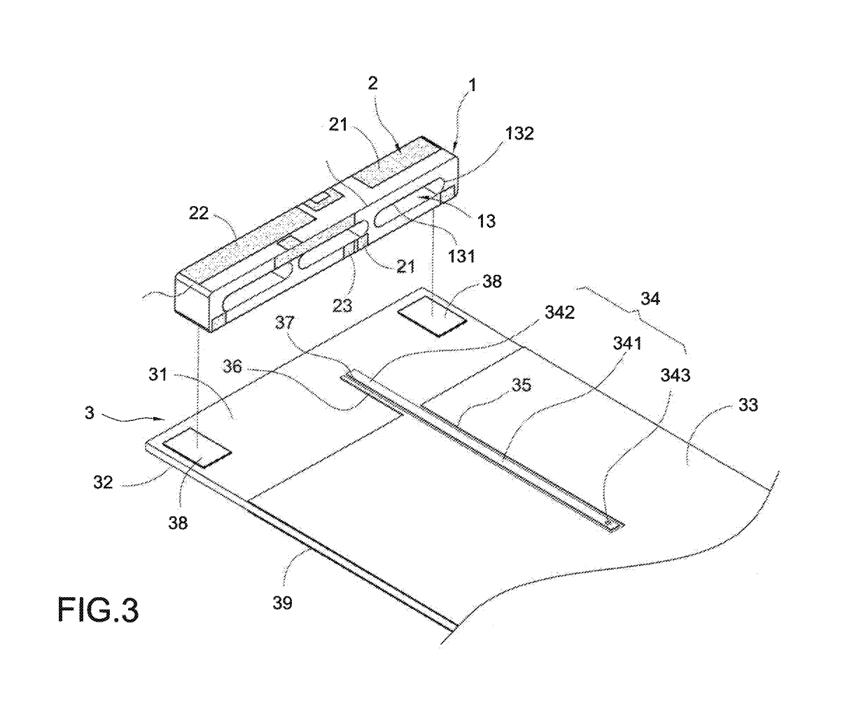

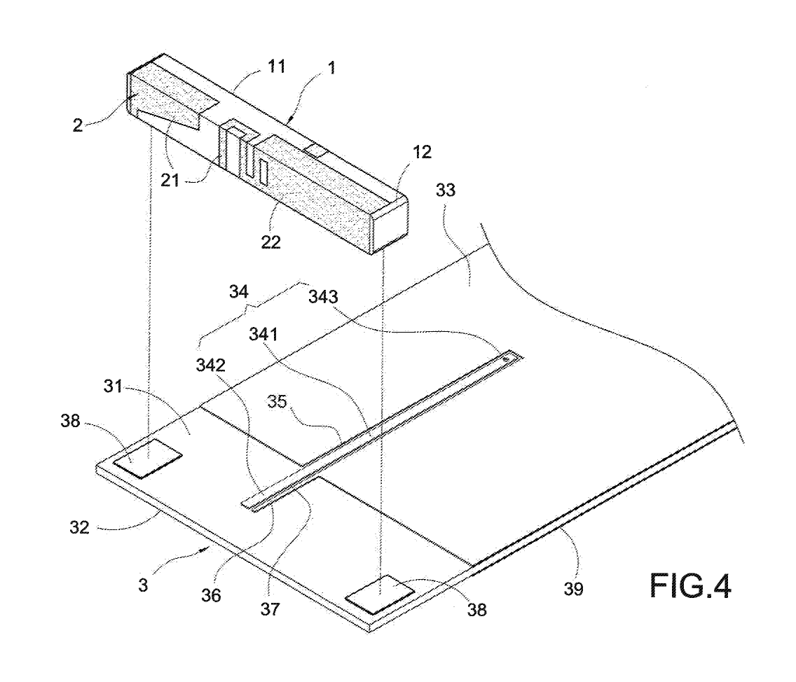

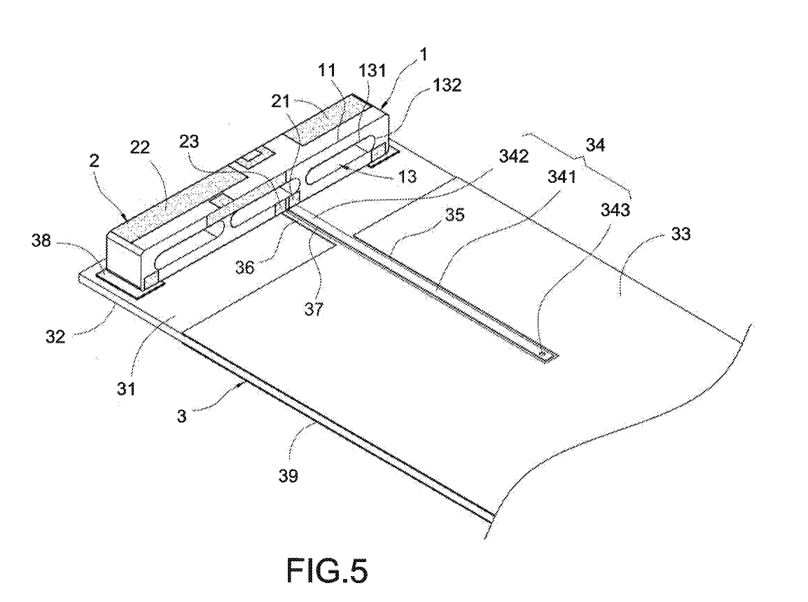

FIG. 3 shows an exploded view of the ceramic antenna and the base plate of the present invention. FIG. 4 shows another exploded view of the ceramic antenna and the base plate of the present invention. FIG. 5 shows an assembly drawing of the ceramic antenna and the base plate of the present invention. The base plate 3 includes a first surface 31 and a second surface 32. A first ground metal surface 33 and a first microstrip line 34 are arranged on the first surface 31. The first microstrip line 34 includes a front segment 341 and a rear segment 342. The front segment 341 includes a perforation 343. The front segment 341 of the first microstrip line 34 is prolonged forward to the first ground metal surface 33. A gap 35 is formed between the front segment 341 and the first ground metal surface 33. The first ground metal surface 33 includes a second microstrip line 36. The second microstrip line 36 is parallel with the rear segment 342 of the first microstrip line 34. A spacing 37 is formed between the rear segment 342 and the second microstrip line 36. A width of the spacing 37 formed between the rear segment 342 and the second microstrip line 36 is adjusted for adjusting a coupling capacitance, so that the first ground metal surface 33 provides a resonance point of high frequency. Therefore, the bandwidth is increased. Moreover, two fixed contacts 38 opposite to each other are arranged on the first surface 31. The two fixed contacts 38 are used to fix the carrier 1. A second ground metal surface 39 is arranged on the second surface 32. The second ground metal surface 39 is used to electrically connect to a ground part of a connector of a coaxial cable (not shown in FIGS. 3, 4, and 5).

The first radiation metal part 21 and the second radiation metal part 22 are electrically connected to the fixed contacts 38 when the carrier 1 is electrically connected to the base plate 3. Therefore, the carrier 1 is fixed connected to the first surface 31 of the base plate 3. A contact connecting the first radiation metal part 21 and the second radiation metal part 22 is electrically connected to the first microstrip line 34. The third radiation metal part 23 is electrically connected to the second microstrip line 36. Therefore, a multi-frequency antenna is provided.

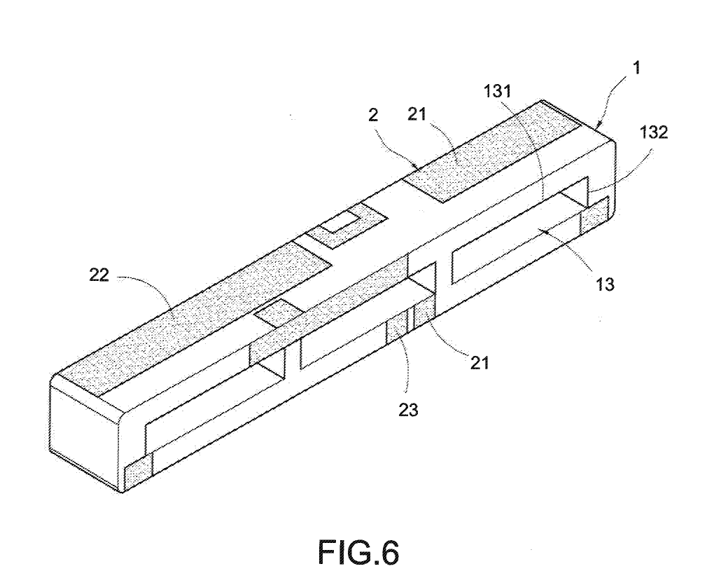

FIG. 6 shows a schematic diagram of another embodiment of the ceramic antenna of the present invention. The content of FIG. 6 is similar with FIG. 2˜5. The difference is that the groove 13 includes two straight long sides 131 and two straight short sides 133. The purpose of the design of the groove 13 is to reduce the weight of the carrier 1 and the usage of the material.

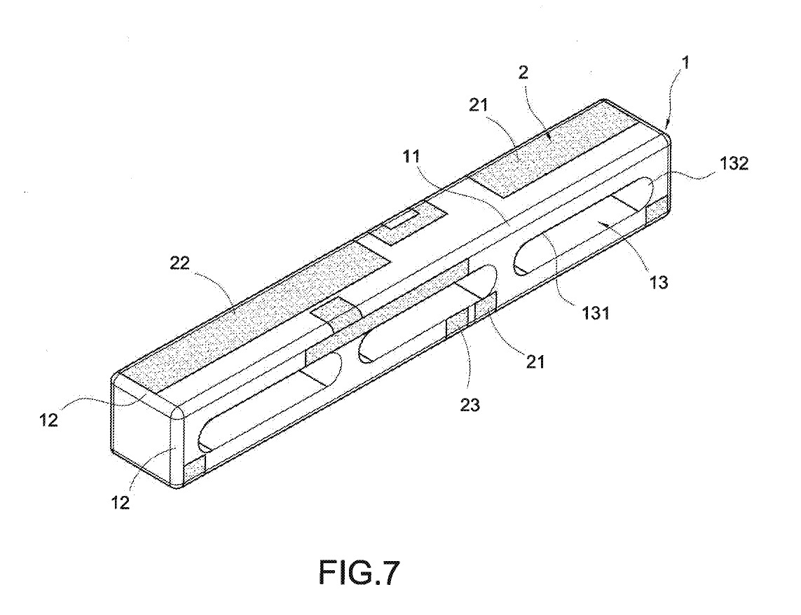

FIG. 7 shows a schematic diagram of still another embodiment of the ceramic antenna of the present invention. The content of FIG. 7 is similar with FIG. 2˜5. The difference is that both the long sides 11 and the short sides 12 are in arc-shape. The radiuses of the long sides 11 in arc-shape and the short sides 12 in arc-shape are between 0.1 mm and 1 mm (best between 0.4 mm and 0.6 mm). Therefore, the short sides 12 of the carrier 1 are not easily broken when moving or manufacturing the carrier 1. The defective rate of the carrier 1 is decreasing.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A ceramic antenna including:
a carrier having a plurality of long sides and a plurality of short sides; and
a radiation metal part arranged on the carrier,
wherein the short sides are in arc-shape.

2. The ceramic antenna in claim 1, wherein a radius of the short side in arc-shape is between 0.1 mm and 1 mm.

3. The ceramic antenna in claim 2, wherein the radius of the short side in arc-shape is between 0.4 mm and 0.6 mm.

4. The ceramic antenna in claim 3, wherein the carrier further includes a plurality of grooves; the groove includes two straight long sides and two arc short sides.

5. The ceramic antenna in claim 3, wherein the carrier further includes a plurality of grooves; the groove includes two straight long sides and two straight short sides.

6. The ceramic antenna in claim 4, wherein the long side is in arc-shape; a radius of the long side in arc-shaped is between 0.1 mm and 1 mm.

7. The ceramic antenna in claim 6, wherein the radius of the long side in arc-shape is between 0.4 mm and 0.6 mm.

8. The ceramic antenna in claim 7, wherein the radiation metal part includes a first radiation metal part, a second radiation metal part, and a third radiation metal part; the first radiation metal part, the second radiation metal part, and the third radiation metal part are in different metal rectangular patterns or metal line patterns arranged on at least a surface of the carrier; the first radiation metal part is electrically connected to the second radiation metal part; the first radiation metal part and the second radiation metal part are not electrically connected to the third radiation metal part.

9. The ceramic antenna in claim 5, wherein the long side is in arc-shape; a radius of the long side in arc-shape is between 0.1 mm and 1 mm.

10. The ceramic antenna in claim 9, wherein the radius of the long side in arc-shape is between 0.4 mm and 0.6 mm.

11. The ceramic antenna in claim 10, wherein the radiation metal part includes a first radiation metal part, a second radiation metal part, and a third radiation metal part; the first radiation metal part, the second radiation metal part, and the third radiation metal part are in different metal rectangular patterns or metal line patterns arranged on at least a surface of the carrier; the first radiation metal part is electrically connected to the second radiation metal part; the first radiation metal part and the second radiation metal part are not electrically connected to the third radiation metal part.
